(19) United States
(12) Patent Application Publication
(10) Pub. No.: US 2015/0110244 A1
(43) Pub. Date: Apr. 23, 2015

(54) X-RAY INSPECTION APPARATUS

(71) Applicant: CANON KABUSHIKI KAISHA, Tokyo (JP)

(72) Inventors: Kazuya Tsujino, Tokyo (JP); Kazuyuki Ueda, Tokyo (JP)

(21) Appl. No.: 14/516,220

(22) Filed: Oct. 16, 2014

(30) Foreign Application Priority Data
Oct. 18, 2013 (JP) 2013-217290

(51) Int. Cl. G01N 23/18; G01N 23/083; G21K 1/02

(52) U.S. Cl. CPC G01N 23/18; G21K 1/02; G01N 23/083
USPC 378/58

(57) ABSTRACT

An X-ray inspection apparatus including: a transmission type X-ray source including an electron emission source configured to emit an electron beam, and a transmission type target; a collimator provided with a plurality of slits formed therein, each slit configured to form a fan beam X-ray by allowing the X-ray radiation emitted from the transmission type X-ray source to pass therethrough; a plurality of detectors arranged at positions where the fan beam X-rays passed through the plurality of slits respectively are irradiated, each of the plurality of detectors configured to detect intensity of the fan beam X-ray passed through a corresponding slit; and a conveying portion configured to convey a sample along a conveying path crossing an irradiation path from each of the collimators to corresponding detector so that the sample is irradiated in sequence with the fan beam X-rays passed through the plurality of slits.

### BACKGROUND OF THE INVENTION

1. Field of the Invention

This disclosure relates to an X-ray inspection apparatus applicable to non-destructive inspection or medical examination and the like; the apparatus may be advantageously configured to inspect interiors of products or packages.

2. Description of the Related Art

In recent years, radiation inspection apparatus having an enhanced inspection processing ability for various samples by employing a method of in-line inspection is known. In such an inspection apparatus, an X-ray inspection apparatus including a plurality of X-ray sources and X-ray detectors arranged respectively in a direction of conveyance of samples and configured to obtain an X-ray image from X-rays transmitted from two directions by one inspection sequence in order to detect foreign substances or abnormal portions accurately at high speed is proposed.

In Japanese Application Patent Laid-Open No. 10-267867, an X-ray inspection apparatus including two sets of inspection apparatus each including a pair of X-ray sources and a pair of X-ray detectors arranged in parallel in the direction of conveyance of the samples is disclosed.

By performing an X-ray inspection from a plurality of directions in this manner, a foreign substance which is located at a portion in a dead angle and hence may be overlooked by the inspection from one direction may be detected by one inspection sequence.

However, in the X-ray inspection apparatus provided with the plurality of X-ray sources in the direction of conveyance of the samples, improvement in uniformization of the quality of a plurality of X-ray beams emitted from the plurality of X-ray sources has been required. In the X-ray inspection apparatus provided with the plurality of X-ray sources in the direction of conveyance of the samples, when an X-ray is radiated continuously in the inspection sequence, power saving for improving energy usage efficiency of the X-ray inspection apparatus is desirable.

To satisfy the above requirements, an X-ray inspection apparatus provided with a collimator having a pair of slits arranged therein for each X-ray source has been proposed. Japanese Patent Application Laid-Open No. 10-513265 describes an X-ray inspection apparatus including an X-ray source, a collimator provided with a plurality of slits, and a plurality of detectors arranged corresponding to the plurality of slits. Japanese Patent Application Laid-Open No. 10-513265 with the configuration as described above discloses enabling radiation of a fan beam X-ray toward each of the plurality of detectors respectively.

As a reference example, an X-ray detector 200 of the related art provided with a reflective type X-ray source 20, a pair of slits 104a and 104b arranged along a direction of conveyance Dt, and a pair of detectors 110a and 110b arranged along the direction of conveyance Dt is illustrated in FIG. 8A. FIG. 8B is a cross-sectional schematic drawing illustrating the X-ray inspection apparatus taken along a cross-sectional plane VIIIB-VIIB in FIG. 8A.

In the X-ray detector 200 of this reference example, because inspection of samples is performed during conveyance, difference in apparent focal sizes observed by detectors 110a and 110b arise. Hereinafter, a focal spot size that the detector detects as an X-ray image is referred to as “apparent focal spot size”.

In the reflective type X-ray source 20, an electron beam 2 emitted from an electron emission source 3 collides against a reflection type target 203, and an X-ray is extracted in a direction away from a normal line Nf of a focal spot 102. At this time, if the direction of extraction with respect to the normal line Nf is different as in the case of fan beam X-rays 106a and 106b formed by the slits 104a and 104b of a collimator 15, the apparent focal spot sizes corresponding to the respective fan beam X-rays 106a and 106b do not match. The apparent focal spot size of the fan beam X-ray 106a which is closer to the normal line Nf becomes larger than the apparent focal spot size of the fan beam X-ray 106b.

The focal spot of the radiation inspection apparatus of this disclosure is practically defined by the focal spot of the electron beam radiated from the electron emission source to the target. Therefore, in this specification, the focal spot of the electron beam being defined by the electron beam on the target and having a limited focal spot diameter is referred to as a focal spot hereinafter.

In this specification, an extraction angle indicates an angle formed by a direction of a center axis of the fan beam X-ray extracted from the focal spot 102 through the slit with reference to the normal line Nf of the focal spot 102.

Extraction angle dependence of the apparent focal spot size will be described with reference to FIGS. 3A and 3C. FIG. 3A is a partly enlarged drawing illustrating the reference example in which a periphery of the reflection type target 203 of the reflective X-ray source 20 illustrated in FIG. 8A is enlarged.

In this reference example, where φ is an angle between the direction of the center of X-ray extraction and an inclined surface of the reflection type target 203 and W is an electron beam irradiation width, the focal spot size viewed in the direction of the center of X-ray extraction becomes W×tan φ. Since φ of the reflection type target is normally on the order of 10 degrees to 20 degrees, the focal spot size becomes a small size on the order of 0.18 to 0.36 times the electron beam irradiation width W.

The focal spot size of the fan beam X-ray extracted in a direction inclined with respect to the direction of the center of X-ray extraction by θ (counterclockwise direction is defined as a positive direction) becomes W/cos θ×sin(φ−θ). Therefore, as illustrated by a broken line in FIG. 3C, a focal spot size of the fan beam X-ray 106b in an area in which the value θ is a positive value is smaller than that in the direction of the center of X-ray extraction, while the focal spot size of the fan beam X-ray 106a in an area in which the value θ is a negative value is larger in contrast.

Therefore, in this reference example, an inspection image obtained by the X-ray detector 110b is clear, while an inspection image obtained by the X-ray detector 110a is not (or vice versa), whereby detection accuracy is disadvantageously lowered.

In order to reduce the influence of a low quality inspection image obtained by the X-ray detector 110a, reducing an angle of opening along directions parallel to the directions of conveyance Dt of the X-rays 106a and 106b is conceivable. However, in the X-ray inspection apparatus employing such an arrangement, the difference between the inspection images obtained by the X-ray inspection from a plurality of directions becomes small and hence detection of a dead angle portion becomes difficult. Therefore, deficiency in detection accuracy arises.

### SUMMARY OF THE INVENTION

According to various embodiments of the present disclosure, an X-ray inspection apparatus includes: a transmission type X-ray source having an electron emission source configured to emit an electron beam, and a target including an emitting surface and an electron irradiation surface which is irradiated with the electron beam and is opposition to the emitting surface; a collimator provided with a plurality of slits formed therein, each slit configured to form a fan beam X-ray by allowing the X-ray radiation emitted from the transmission type X-ray source to pass therethrough; a plurality of detectors arranged at positions where the fan beam X-rays passed through the plurality of slits respectively are irradiated, each of the plurality of detectors configured to detect intensity of the fan beam X-ray passed through a corresponding slit; and a conveying portion configured to convey a sample along a conveying path crossing an irradiation path from each of the collimators to corresponding detector so that the sample is irradiated in sequence with the fan beam X-rays passed through the plurality of slits.

Further features of the present invention will become apparent from the following description of exemplary embodiments with reference to the attached drawings.

### BRIEF DESCRIPTION OF THE DRAWINGS

FIG. 1 is a schematic drawing illustrating an example of an X-ray inspection apparatus of a first embodiment.

FIG. 2 is a partly enlarged view of a periphery of a target of the first embodiment.

FIG. 3A is a schematic drawing for explaining emission angle dependence for a reflective type target.

FIG. 3B is a schematic drawing for explaining emission angle dependence for a transmission type target.

FIG. 3C is a graph showing emission angle dependence of a focal spot size for the targets of respective types.

FIG. 4 is a schematic drawing illustrating an example of the X-ray inspection apparatus of a second embodiment.

FIGS. 5A and 5B are a schematic drawing and a schematic cross-sectional drawing illustrating an example of the X-ray inspection apparatus of a third embodiment.

FIGS. 6A, 6B, and 6C are schematic drawings of an embodiment, a modification, and another modification, respectively, of a pair of slits for illustrating a relationship the pair of slits to the direction of conveyance.

FIGS. 7A and 7B are schematic drawings illustrating a relationship between a pair of slits of a reference example and the direction of conveyance.

FIGS. 8A and 8B are a schematic drawing and a schematic cross-sectional drawing, respectively, illustrating an X-ray inspection apparatus of the reference example to which a reflective X-ray source is applied.

### DESCRIPTION OF THE EMBODIMENTS

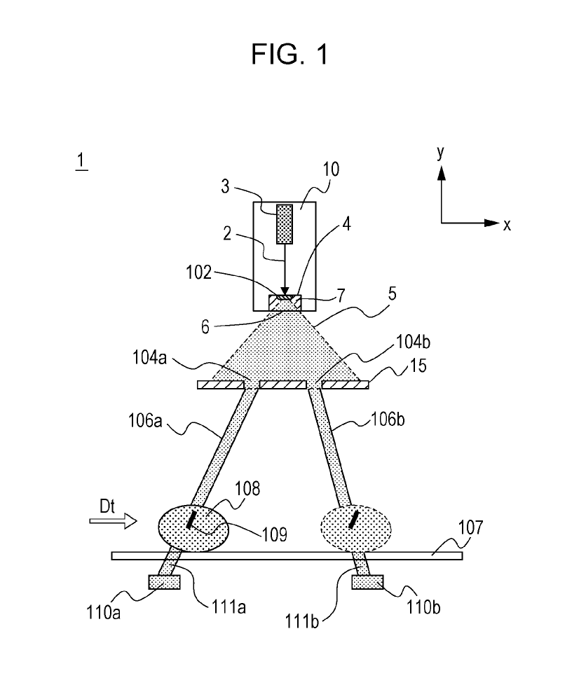

Embodiments included in an X-ray inspection apparatus of this disclosure will be described with reference to FIG. 1 to FIG. 7. Examples of a destructive inspection to which the X-ray inspection apparatus of this disclosure can be applied include a product detection that detects defects, foreign substances, abnormal portions, or the like present in a sample or detects the presence or absence of missing parts as an image contrast of a transmission-type X-ray.

### First Embodiment

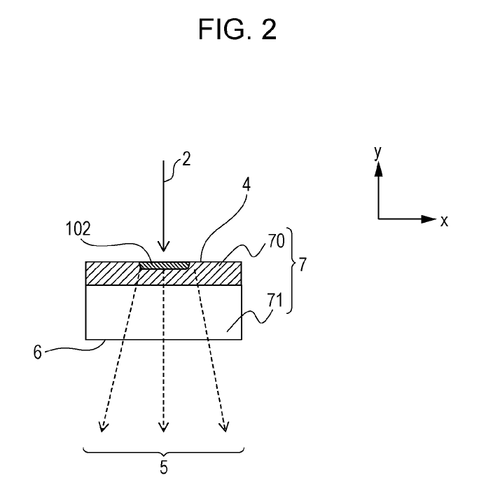

FIG. 1 and FIG. 2 are schematic drawings illustrating an X-ray inspection apparatus 1 of a first embodiment of this disclosure. The X-ray inspection apparatus 1 of the first embodiment includes a transmission type X-ray source 10 provided with a transmission type target 7, a collimator provided with a pair of slits 104a and 104b, a conveying portion, and a pair of detectors 110a and 110b as illustrated in FIG. 1.

First, the transmission type X-ray source 10 will be described with reference to FIG. 1 and FIG. 2. The transmission type X-ray source 10 includes at least an electron emission source 3 and the target 7 arranged so as to oppose the electron emission source 3 as illustrated in FIG. 1. The electron emission source 3 and the target 7 are stored respectively in a vacuum container, and the target 7 is connected to an opening of the vacuum container to constitute an end window of the transmission type X-ray source 10.

The electron emission source 3 includes an electron emission mechanism, and a cold cathode electron source such as a CNT (carbon nano tube) or Spindt or a hot cathode electron source such as a filament type or an impregnating type. In terms of symmetry of the shape of the electron focal spot, an impregnating type hot cathode is preferably employed as the electron emission source 3.

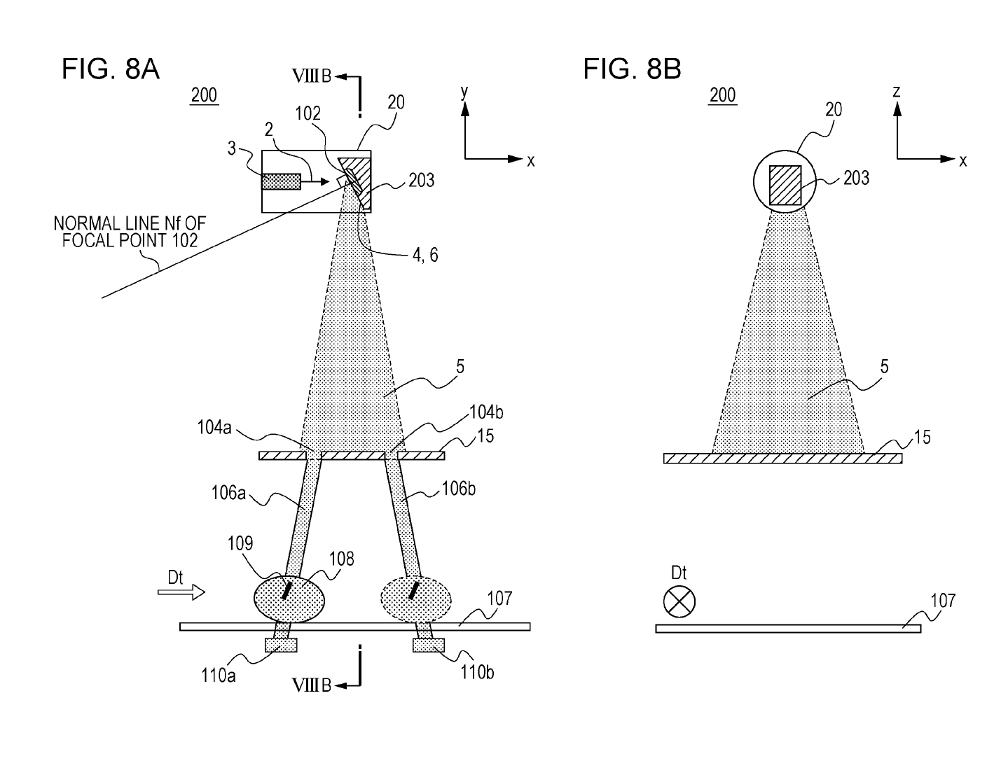

An electron irradiation surface 4 of the target 7 is irradiated with an electron beam 2 emitted from the electron emission source 3 as illustrated in FIG. 2 to form a focal spot 102 (focal region). An X-ray generated at the focal spot 102 is transmitted from the focal spot through the target 7, and is emitted to the side facing the electron emission source 3 (outside the vacuum container) as an X-ray 106. The electron irradiation surface 4 is arranged in parallel to a direction of conveyance Dt and a width of conveyance perpendicular to the direction of conveyance. In other words, the electron irradiation surface 4 is arranged in parallel to a conveying portion 107. As illustrated in FIG. 8B, by arranging the electron irradiation surface 4 in parallel to the conveying portion 107, a symmetry of the fan beam X-rays 106a and 106b in a fan angle direction can be secured

In the first embodiment, the target 7 includes a target layer 70 and a transmission-type base material 71 configured to support the target layer as illustrated in FIG. 2. The target layer 70 contains at least a heavy metal element such as tungsten, rhenium, molybdenum, or tantrum which has a good X-ray generating efficiency and good heat resistance property. The target layer 70 has a layer thickness within a range from 0.5 times to 2 times an electron beam entry length, whereby self-attenuation caused by absorption of the target layer itself is restrained and a generation efficiency of the radiation extracted to the outside the target layer can be enhanced. The layer thickness of the target layer 70 in a range from 0.5 μm to 10 μm inclusive is employed.

The transmission-type base material 71 is preferably a material having a good heat discharging property and a good X-ray transmitting property and, for example, a light element material such as diamond or beryllium. In the case where the transmission-type base material 71 includes diamond, monocrystalline diamond or polycrystalline diamond is applied. In terms of restriction of the X-ray attenuation or securement of heat discharging property and vacuum retaining property, a thickness within a range from 0.2 mm to 3 mm is employed as the thickness of the transmission-type base material 71.

Subsequently, the mutual arrangement relationship among the transmission type X-ray source 10, a collimator 15, the conveying portion 107, and the detectors 110a and 110b which constitute the X-ray inspection apparatus 1 of the first embodiment will be described

As illustrated in FIG. 1, the collimator 15 having the pair of slits 104a and 104b is arranged on a side of an emitting surface 6 of the target 7 of the transmission type X-ray source 10 so as to face the emitting surface 6. An X-ray of a conical shape or a fan shape having a radiation angle so as to pass through both of the pair of slits 104a and 104b is emitted from the transmission type X-ray source 10. The X-ray passed through the pair of slits 104a and 104b has a fan shape having a fan angle corresponding to an irradiation range larger than the size of an interested portion of the sample and a radiation angle corresponding to an irradiation range sufficiently smaller than the size of the interested portion of the sample.

The conveying portion 107 capable of moving the sample in the predetermined direction of conveyance Dt is arranged on the side opposite to a side where the collimator 15 faces the emitting surface 6. The conveying portion 107 conveys the sample so as to be irradiated with the fan beam X-rays passing though the respective slits 104a and 104b between the collimator 15 and the detectors 110a and 110b.

The predetermined direction of conveyance Dt and the pair of slits 104a and 104b satisfy a mutual geometric relationship described later. The pair of detectors 110a and 110b are arranged on extensions passing respectively through the pair of slits 104a and 104b from the focal spot 102 of the transmission type X-ray source 10 on a side farther from the conveying portion 107 in terms of a distance from the focal spot 102.

The collimator 15 separates a radiation 5 emitted from a single transmission type X-ray source into a pair of fan beam X-rays 106a and 106b. The pair of detectors 110a and 110b detect sequentially the intensities of the fan beam X-rays passed through the identical sample and output an electric signal corresponding to the detected intensity. Each of the pair of detectors 110a and 110b obtains a different transmitted X-ray image 111a or 111b with an image processing unit (not illustrated) respectively. Each of the transmitted X-ray images 111a and 111b contains visual difference information based on an apparent geometrical relationship between an irregular particle 109 and a sample 108. The apparent geometrical relationship between the irregular particle 109 and the sample 108 contains a relative angle and a relative position of the particle 109 respect to the sample 109. Said visual difference information is defined with a positional relationship between the pair of slits 104a and 104b and the focal spot 102.

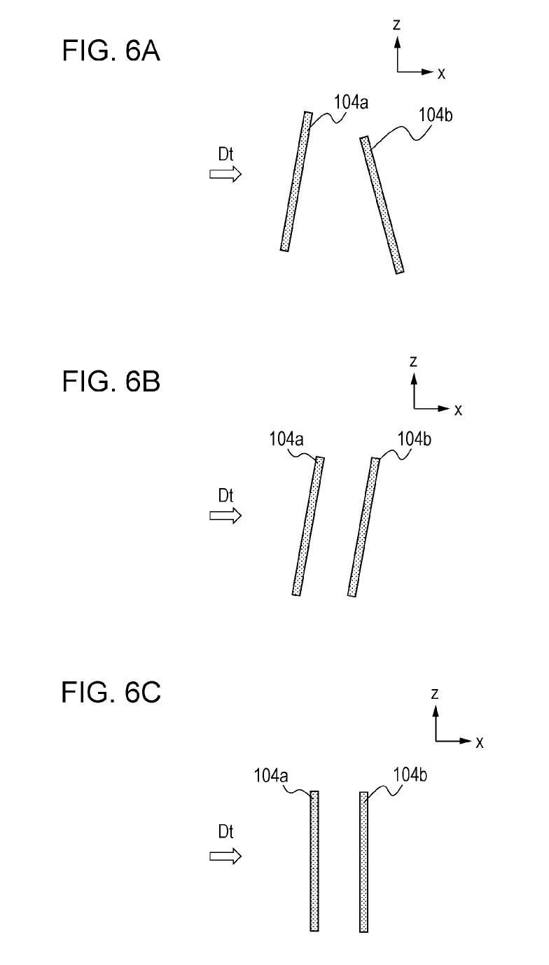

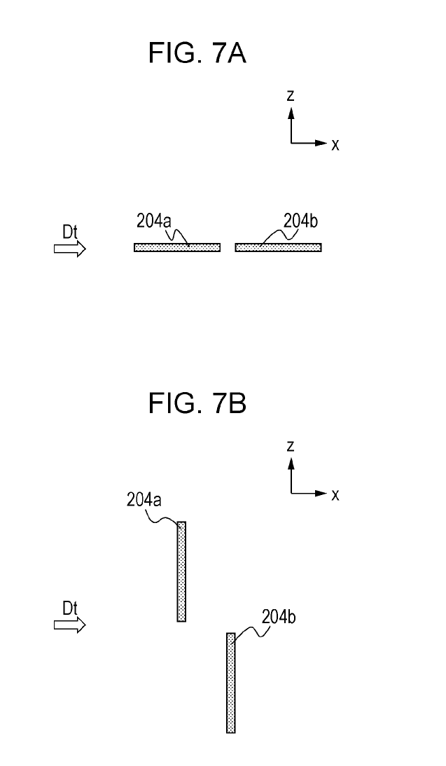

Subsequently, the arrangement relationship between a pair of the slits required for obtaining the two X-ray transmitted images including the visual difference information will be described with reference to FIG. 1, FIGS. 6A to 6C, and FIGS. 7A and 7B.

The arrangement relationship of the slits of the collimator 15 which can be applied to the X-ray inspection apparatus 1 of this disclosure is illustrated in the respective drawings in FIGS. 6A to 6C. The slits 104a and 104b each have an elongated shape having a longitudinal direction and a short direction, respectively, and are a rectangle in the first embodiment. The slits 104a and 104b are preferably the same shape. In the embodiment illustrated in FIG. 6A, the pair of slits 104a and 104b are arranged so as to have portions overlapping each other along the direction of conveyance Dt, and are not arranged on the same straight line. In the first embodiment, the pair of slits 104a and 104b are in a non-parallel relationship, and the lengths of the respective slots in the longitudinal directions are different from each other.

The pair of slits 104a and 104b described in FIG. 6B are modifications of the embodiment illustrated in FIG. 6A, are parallel to each other in a direction intersecting the direction of conveyance Dt, and are different from the embodiment illustrated in FIG. 6A in that the length of the slit in the longitudinal direction are the same.

The embodiment illustrated in FIG. 6C is a modification of the embodiment illustrated in FIG. 6B. The slits 104a and 104b in FIG. 6B are inclined with respect to the direction of conveyance Dt respectively. In contrast, the slits 104a and 104b in FIG. 6C are respectively arranged so that the longitudinal directions thereof are oriented in a direction perpendicular to the direction of conveyance Dt.

As described above, in the arrangement relationship of the plurality of slits, a technological significance achieved by two conditions; “how to overlap in the direction of conveyance” and “not on identical line” will be described with reference to FIGS. 7A and 7B.

As illustrated in a first reference example illustrated in FIG. 7A, in a mode in which a pair of slits 204a and 204b are present on the identical line, the visual difference information is not included in a plurality of transmitted image detected corresponding to the plurality of slits, and hence the effect of reducing a dead angle is not achieved. In the case, in which a pair of slits 204a and 204b are present displaced form each other, where no portion is overlapped with each other along the direction of conveyance Dt as illustrated in FIG. 7B, information overlapped with the image information of the sample is not included in the plurality of transmitted images, and hence the effect of reducing the dead angle is not achieved.

Therefore, in the collimator 15, at least two slits need to include portions overlapping each other along the direction of conveyance Dt of the conveying portion 107, and to be arranged so that the longitudinal directions thereof are not present on an identical line.

The collimator 15 may be formed of a heavy metal such as lead, tungsten, or molybdenum, but the material is not limited thereto.

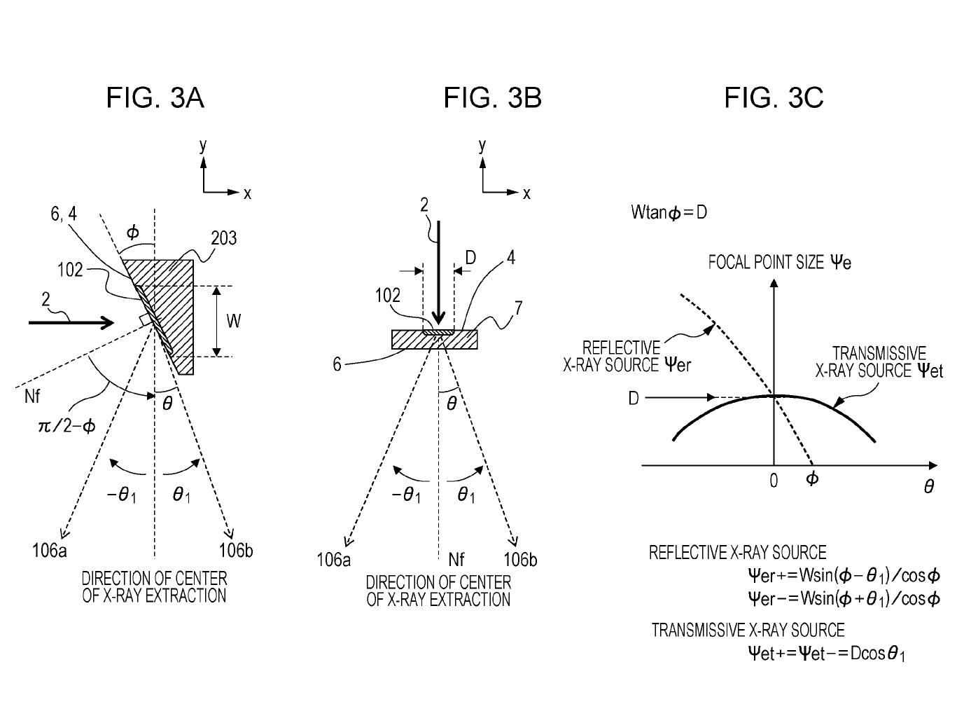

Subsequently, in the X-ray inspection apparatus provided with the transmission type X-ray source 10 and the collimator 15 having the plurality of slits, difference in apparent focal spot size between the fan beam X-rays 106a and 106b will be described with reference to FIGS. 3B and 3C.

FIG. 3B is a drawing of a periphery of the target 7 of the transmission type X-ray source 10 mounted on the X-ray inspection apparatus 1 of this disclosure. The target 7 is irradiated with the electron beam 2, and an X-ray is emitted from the focal spot 102. The target 7 is different from a reflection type target 203, and can be arranged so that the electron beam 2 is incident on the electron irradiation surface 4 perpendicularly thereto as in the first embodiment. In the transmission type X-ray source 10, the X-ray passed through the target 7 is utilized.

Assuming an electron beam irradiation width is D, the apparent focal spot size viewed in the direction of the center of X-ray extraction is D. In contrast, the apparent focal spot size of the X-ray emitted in the direction inclined by an angle θ (the counterclockwise direction is a positive direction) [°] with respect to the direction of the center of X-ray extraction is D×cos θ.

Therefore, as apparent from the comparison between a solid line and a broken line in FIG. 3C, a change in apparent focal spot size of the X-ray inspection apparatus 1 of the first embodiment provided with the target 7 is smaller than that of the X-ray inspection apparatus 200 of the reference example provided with the reflection type target 203. Therefore, variations in apparent focal spot size of the X-ray inspection apparatus 1 provided with the transmission type X-ray source 10 can be reduced.

In the example illustrated in FIG. 3B, in the case where D=1 mm and the angle θ with respect to the direction of the center of X-ray extraction is from −20 degrees to +10 degrees, the apparent focal spot sizes with respect to the angle θ (0 degrees, +10 degrees, and −20 degrees) are 1.0 mm, 0.97 mm, and 0.94 mm, respectively. Consequently, in this example, a change rate of the apparent focal spot size is obtained from ΔΨet/Ψet(0°)=(1.0−0.94)/1.0 and is approximately 6%.

In contrast, in the reference example illustrated in FIG. 3A, in the case where W=2.8 mm, φ=20 degrees, and the angle θ is from −20 degrees to +10 degrees, the apparent focal spot sizes with respect to the angle θ (0 degrees, +10 degrees, and −20 degrees) are 1.02 mm, 0.52 mm, and 1.92 mm, respectively. Consequently, in this reference example, a change rate of the apparent focal spot size is obtained from ΔΨer/Ψer(0°)=(1.92−0.52)/1.02 and is approximately 137%.

From the consequence described above, it is understood that the X-ray inspection apparatus 1 illustrated in FIG. 1 provides an effect of reducing the difference in focal size due to the difference in the direction of extraction of the X-ray in comparison with the X-ray detector 200 of the reference example illustrated in FIGS. 8A and 8B.

### Second Embodiment

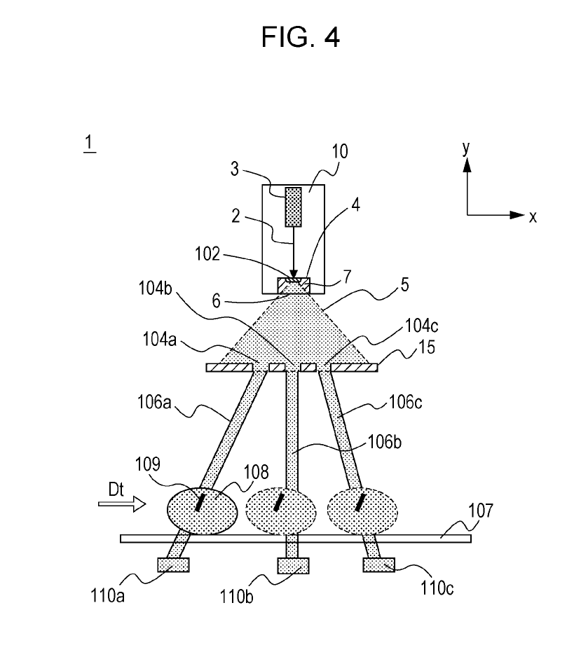

FIG. 4 is a drawing for explaining an example of a second embodiment of the X-ray inspection apparatus 1 of this disclosure.

In the second embodiment, the slits 104a, 104b, and 104c are respectively arranged so that the longitudinal directions thereof extend in parallel to each other and with respect to the direction of conveyance Dt as illustrated in FIG. 6B. Each of the fan beam X-rays 106a, 106b, and 106c formed corresponding to the respective slits are irradiated toward the detectors 110a, 110b, and 110c.

The second embodiment is different from the first embodiment in that the number of the arranged slits is three in the direction from an upstream side to a downstream side of the direction of conveyance Dt, and the number of arrangement of the X-ray detectors arranged in the direction described above is three.

In this configuration, the X-ray inspection in which the number of direction of irradiation of the fan beam X-ray is further increased in a series of inspection sequence is enabled, so that the accuracy for detecting the foreign substance or the like can further be enhanced.

In the second embodiment, the configuration including the three slits and the three detectors has been exemplified. However, this disclosure is not limited thereto, and a modification in which four or more slits and the detectors are arranged is also included in the second embodiment.

### Third Embodiment

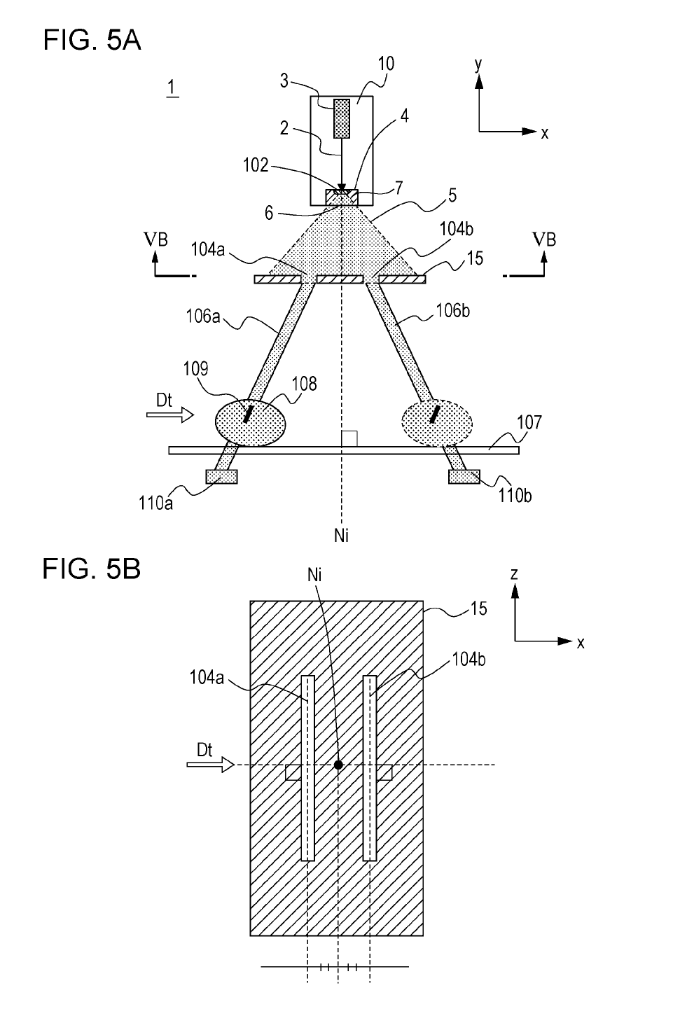

FIG. 5A is a drawing for explaining an example of a third embodiment of the X-ray inspection apparatus 1 of this disclosure. FIG. 5B is an enlarged schematic drawing of the collimator 15 taken along the cross section VB-VB in FIG. 5A.

The third embodiment is different from the first embodiment in that at least the two slits 104a and 104b are arranged at positions symmetry with each other with respect to a virtual perpendicular line Ni extending downward from a center of the focal spot 102 toward the conveying portion 107 on a virtual plane defined by the direction of conveyance Dt and the center of the focal spot 102. The virtual plane defined by the direction of conveyance Dt and the center of the focal spot 102 corresponds to an x-y plane in FIG. 5A.

The points that each of the pair of detectors 110a and 110b are arranged on extensions connecting the focal spot 102 and the pair of slits 104a and 104b, and that the electron irradiation surface 4 extends in parallel to the direction of conveyance Dt are the same as in the first embodiment.

According to the third embodiment, the focal spot sizes in the two transmission type X-ray images detected respectively by the pair of detectors 110a and 110b can be equalized. Consequently, the X-ray inspection apparatus of the third embodiment enables to obtain high-quality subtraction images. Therefore, the influence of the dead angle is reduced further reliably than in the first embodiment, or the X-ray inspection which is capable of detecting smaller foreign substances is achieved.

According to the X-ray inspection apparatus of this disclosure, the difference in focal spot sizes depending on the direction of irradiation may be reduced more than the related art even when the plurality of fan beam X-rays are used, so that lowering of energy efficiency may be restrained without impairing inspection accuracy.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-217290, filed Oct. 18, 2013 which is hereby incorporated by reference herein in its entirety.

What is claimed is:

1. An X-ray inspection apparatus comprising:
a transmission type X-ray source including an electron emission source configured to emit an electron beam, and a target including an emitting surface and an electron irradiation surface which is irradiated with the electron beam and is opposition to the emitting surface;
a collimator provided with a plurality of slits formed therein, each slit configured to form a fan beam X-ray by allowing the X-ray radiation emitted from the transmission type X-ray source to pass therethrough;
a plurality of detectors arranged at positions where the fan beam X-rays passed through the plurality of slits respectively are irradiated, each of the plurality of detectors configured to detect intensity of the fan beam X-ray passed through a corresponding slit; and
a conveying portion configured to convey a sample along a conveying path crossing an irradiation path from each of the collimators to corresponding detector so that the sample is irradiated in sequence with the fan beam X-rays passed through the plurality of slits.

2. The X-ray inspection apparatus according to claim 1, wherein
at least two slits out of the plurality of slits have overlapping portions in a direction of conveyance of the conveying path, and the two slits are not aligned on an identical line.

3. The X-ray inspection apparatus according to claim 2, wherein
the two slits are parallel to each other.

4. The X-ray inspection apparatus according to claim 2, wherein
each of the two slits is arranged longitudinally in a direction perpendicular to the direction of conveyance.

5. The X-ray inspection apparatus according to claim 2, wherein
a focal spot is formed by the electron beam on the electron irradiation surface,
the electron irradiation surface is parallel to the direction of conveyance, and
the plurality of slits includes at least the two slits arranged at positions symmetric with respect to a virtual perpendicular line extending from a center of the focal spot toward the conveying portion on a plane defined by the center of the focal spot and the direction of conveyance.

6. The X-ray inspection apparatus according to claim 1, wherein
the target includes a target layer configured to generate an X-ray by an incoming electron and a transmission-type substrate configured to support the target layer.

7. The X-ray inspection apparatus according to claim 6, wherein
the target layer contains at least a metallic element selected from a group of tungsten, rhenium, molybdenum, and tantalum.

8. The X-ray inspection apparatus according to claim 6, wherein
the target layer has a thickness from 0.5 times to 2 times of an electron beam length.

9. The X-ray inspection apparatus according to claim 6, wherein
the target layer has a thickness from 0.5 μm to 10 μm.

10. The X-ray inspection apparatus according to claim 6, wherein
the transmission-type substrate includes monocrystalline diamond or polycrystalline diamond.

11. The X-ray inspection apparatus according to claim 6, wherein
the transmission-type substrate has a thickness from 0.2 mm to 3 mm.

12. The X-ray inspection apparatus according to claim 1, wherein
the electron emission source is an impregnated hot cathode.

13. An X-ray inspection apparatus comprising:
a transmission type X-ray source configured to emit X-ray radiation;
a collimator provided with a plurality of slits formed therein, each slit configured to form a fan beam X-ray by allowing the X-ray radiation emitted from the transmission type X-ray source to pass therethrough;
a plurality of detectors arranged at positions where the fan-shaped X-ray beams passed through the plurality of slits respectively are irradiated, each of the plurality of detectors configured to detect intensity of the fan beam X-ray passed through a corresponding slit; and
a conveying portion configured to convey a sample along a conveying path crossing an irradiation path from each of the collimators to corresponding detector so that the sample is irradiated in sequence with the fan beam X-rays passed through the plurality of slits.

14. The X-ray inspection apparatus according to claim 13, wherein each of the plurality of fan-shaped X-ray beams forms an apparent focal spot on a detecting surface of corresponding one of the plurality of detectors, and wherein a size difference among the plurality of apparent focal spots is equal to or less than 6%.
